(19) United States
(12) Patent Application Publication
(10) Pub. No.: US 2010/0129180 A1
(43) Pub. Date: May 27, 2010

(54) SECURED BINDING SYSTEM FOR ENSURING THE AUTHENTICITY OF A DOCUMENT

(75) Inventor: Stephane Wilpart, Lille (FR)

Correspondence Address: SUGHRUE MION, PLLC, 2100 PENNSYLVANIA AVENUE, N.W., SUITE 800, WASHINGTON, DC, 20037, US

(73) Assignee: VISU-AD, Hellemes (FR)

(21) Appl. No.: 12/598,334

(22) PCT Filed: Apr. 30, 2008
(86) PCT No.: PCT/IB2008/002388

§ 371 Date: Jan. 12, 2010

(30) Foreign Application Priority Data
May 2, 2007 (FR) 07/54817

(51) Int. Cl. B42B 5/08

(52) U.S. Cl. 412/38

(57) ABSTRACT

Secured binding system (1) for a document. The system comprises two strips (11, 13) each provided with an inner face (17, 21) and an outer face (19, 23). The first strip (11) comprises at least one tab (29, 29′) extending over its inner face (17) and arranged so as to be inserted into a perforation in the document, then into a corresponding perforation (31, 31′) made in the second strip (13). The tab is arranged to be folded down and attached to the outer face (23) of the second strip (13). The system (1) comprises irreversible assembly means arranged to allow a single attachment of the tab (29, 29′) to the outer face (23) and to mark said outer face (23) in the event of removal of the tab (29, 29′), and authentication means (41, 43, 48) of said binding system (1) integral with the document.

The present invention relates to a secured binding system for documents such as contracts, notarial instruments, official reports and authentic instruments under private signature. In particular, the present invention will be implemented by manufacturers of accessories for binding documents.

Official documents such as contracts, reports and notarial instruments are currently authenticated by the initialing of all pages of the official document as defined above. This initialing is a disadvantage because it results in a serious loss of time, particularly when the documents are voluminous and multiple copies must be signed.

To remedy this disadvantage, a device is known that is described in the document FR 2.471.866. This device makes it possible to bind a sheaf of pages together and possibly to a support. It comprises at least one tab irremovably forming one piece with one of the exterior pages of the sheaf, capable of entering into a series of overlapping slits that pass through the rest of the pages to be bound, and of being pulled down and attached irremovably by gluing on the other exterior page of the sheaf. Thus, it is impossible to remove a page from the sheaf without tearing said page at its slit or without cutting or tearing the tab that passes through the sheaf. The glue can include a dye to indicate any fraudulent attempt to unglue the tab, said dye being capable of migrating in the material of the sheaf in order to leave an indelible trace. Moreover, the exterior page of the sheaf bears an indelible mark such as an ink stamp that at least partially covers the tab glued to said exterior page.

A disadvantage of such a design is that it does not completely prevent the falsification of the document. Indeed, a fraudulent person who is able to obtain such a device and indelible marking means such as the ink stamp is then capable of removing the existing device on the official bound document in order to modify the contents thereof, then to install a new device, while taking care to replace the exterior page on which the tab is attached in order to avoid any detection of the dye that might appear during the ungluing of the tabs of the initial device. The fraudulent person can then mark the document by an ink stamp.

The object of the invention is to prevent any risk of falsification of the document by fraudulent persons capable of obtaining devices for the binding of official documents.

Indeed, the present invention has the advantage of ensuring the integrity of the binding system used on the document, said integrity of the binding system guaranteeing the authenticity of the document.

Thus, the invention proposes a secured document binding system, said document being perforated and having a recto side and a verso side, said document being composed of at least one page.

The binding system according to the invention comprises a first strip and a second strip each of which has an inner face and an outer face. The two strips are connected to each other by means of a folding zone made between the adjacent longitudinal sides of the two strips. The first strip comprises at least one tab that extends on its inner face; said tab is arranged so as to be inserted into the perforation of the document, and particularly of all of the pages of the document, then into a corresponding perforation made in the second strip. This insertion of the tab into the perforation of the document and into the second strip is performed when the inner faces of the two strips are folded opposite each other on the recto and verso sides of the document. The tab is arranged so as to be folded over and attached to the outer face of the second strip in such a way as to maintain the binding system secured to the document.

The system comprises at least irreversible means of assembly that are arranged to allow one single attachment of the tab folded onto the outer face of the second strip. Said irreversible assembly means are also arranged to mark said outer face in the event of attempt to remove the tab in order to open the binding system and access the document. The binding system also comprises means of authenticating said system that are integral with the document, said authentication means being arranged so as to guarantee the uniqueness of the binding system and thus the authenticity of the document to which said binding system is secured.

It will thus be understood that any attempt at falsification of the document would result in the need to replace the binding system installed on the document. The irreversible attachment means ensure a single use of the binding system; this requires it to be replaced in order to allow the binding of the document in the event of fraud. The authentication means are unique and peculiar to a binding system. This makes it possible to detect whether the binding system in place corresponds properly to the one that was initially placed on the document.

According to a preferred embodiment, the irreversible assembly means are composed of an adhesive film arranged on the inner face of the tab. Said tab is capable of being folded onto the outer face of the second strip in order to apply the inner face of the tab, including the adhesive film, onto said outer face of the second strip, and thus to ensure the adhering of said inner face of the tab onto said outer face of the strip. When the tab is detached from the outer face, the adhesive film is detached and leaves a colored mark on the outer face of the second strip. Moreover, the detachment of the adhesive film prevents the re-adhering of the tab onto the outer face of the second strip.

According to one embodiment, the authentication means comprise at least one identifying code that appears during the marking left by the adhesive film on the outer face of the second strip when the tab is detached after it has been adhered.

According to a variation of embodiment, the authentication means comprise a DNA tracer integrated into the adhesive film, said DNA tracer being released when the tab is detached from the outer face of the second strip.

Preferably, the authentication means of the binding system comprise a bar code that is arranged on at least one of the outer faces of the two strips, said bar code enabling the identification of the document.

Preferably, the authentication means comprise at least one hologram arranged on one of the outer faces of the two strips. The purpose of said hologram is to identify the binding system.

Preferably, the inner faces of the two strips comprise irreversible assembly means arranged to make possible a single attachment of said inner faces on the recto and verso sides of the document. Said irreversible assembly means on the inner faces of the two strips are composed of an adhesive film capable of allowing the adhering of the inner faces onto the recto and verso sides of the document, said adhesive film leaving a colored marking when the strips are detached from the document. Moreover, said adhesive film prevents the re-adhering of the inner faces once they are detached from the recto and verso sides of the document.

Preferably, the authentication means comprise an identifying code that appears during the marking left by the adhesive film detached from the inner faces when they are detached from the recto and verso sides of the document.

Preferably, the authentication means comprise a DNA tracer integrated into the adhesive film on the inner faces of the two strips. Said DNA tracer is released when at least one of the two strips is detached from the recto side or the verso side of the document.

Preferably, the binding system is composed at least partially of a transparent material. Said transparent material integrates authentication means comprising at least a color code, particularly invisible to the naked eye, said color code being unique and peculiar to said binding system.

Preferably, the binding system comprises locking means. Said locking means are arranged between the tab on the first strip and the perforation of the second strip. Said locking means are capable of preventing an increase in the space separating the two strips when they are folded onto the document, said space corresponding to the thickness of the document, since the increase of the space can generate stresses at the tab attached to the outer face of the second strip.

According to a first embodiment, said locking means are composed of a protruding part arranged at the periphery of the perforation of the second strip, and at least one corresponding orifice provided on the tab. The protruding part is capable of being inserted into the orifice when the tab is inserted into the perforation of the second strip and the inner faces of the two strips are pressed onto the recto and verso sides of the document.

According to a variation of embodiment, said locking means are composed of a non-return system arranged on the tab to allow its insertion through the perforation on the second strip, the part of the tab inserted into the perforation being locked thereby, thus preventing its release, said locking of the tab avoiding any stress on the locked part which is intended to be attached to the outer face of the second strip.

In a preferred and non-limiting manner, the second strip comprises at least one slit that extends from the perforation to the outer longitudinal edge of said strip. Said slit is capable of allowing the passage of the tab in order to facilitate its insertion through the perforation.

Preferably, the binding system comprises at least one disc integral with the strips, particularly when the document comprises at least two perforated pages. Said disc is provided with irreversible attachment means allowing its single attachment to the recto face or the verso face of one of the pages of the document, particularly positioned in the insert parts of said document. Said irreversible attachment means are capable of marking said face in the event the disc is removed, and capable of preventing the re-adhering of said disc.

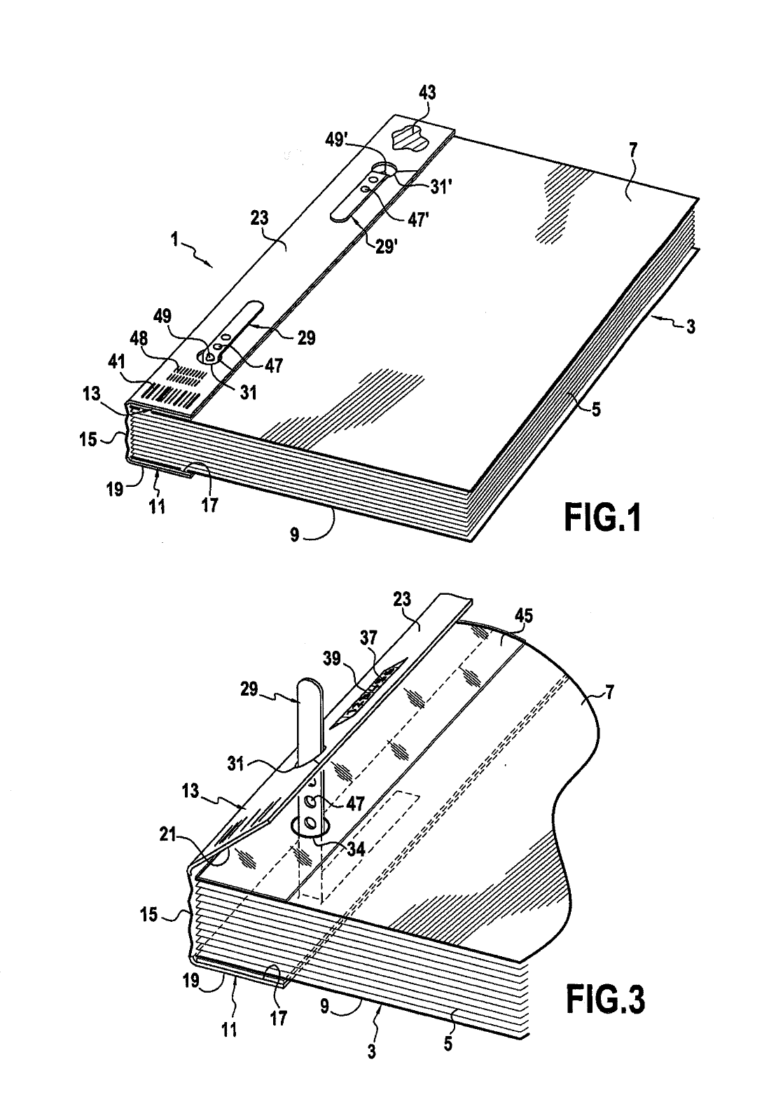

The present invention will be better understood from the following description based on FIGS. 1 to 4 in which:

FIGS. 1 to 3 represent a first embodiment of the binding system,

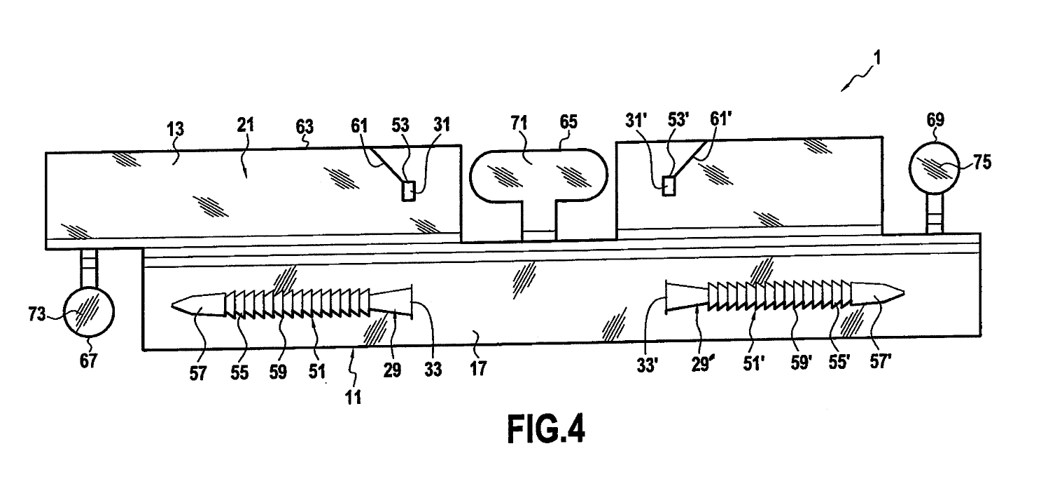

FIG. 4 represents a second embodiment of the binding system.

FIG. 1 represents the binding system installed on a document to guarantee its authenticity.

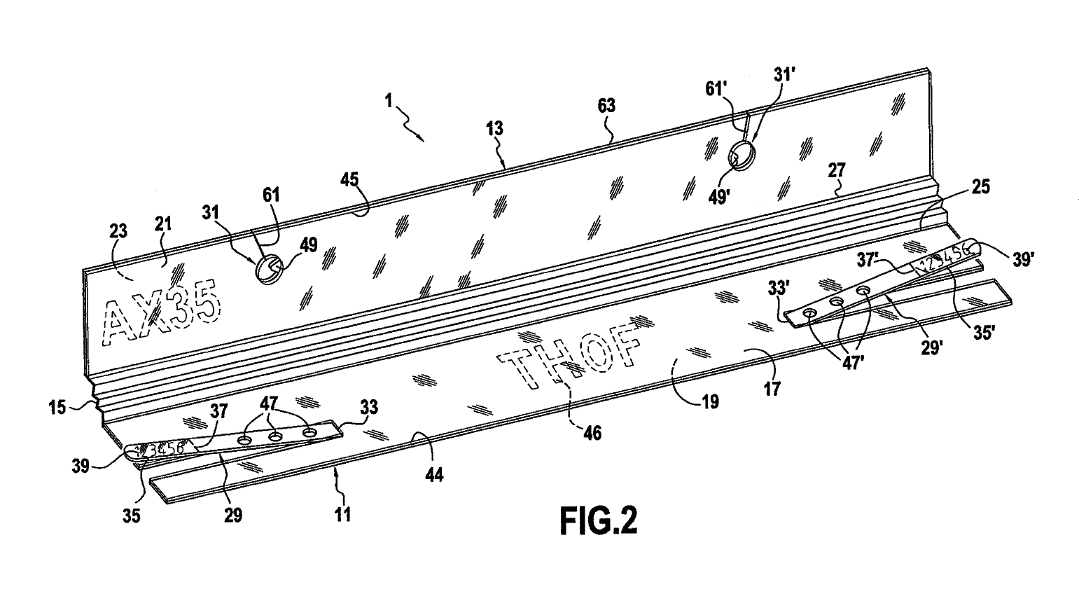

FIG. 2 provides a view in perspective of the binding system showing the first strip and the second strip connected by the folding zone, the first strip comprising tabs and the second strip comprising perforations suitable for receiving the tabs.

FIG. 3 represents the binding system when it is separated from the document to be authenticated.

FIG. 4 shows a first variation of the binding system prior to use, said system being provided in particular with a second embodiment of the locking means of the tabs on the second strip.

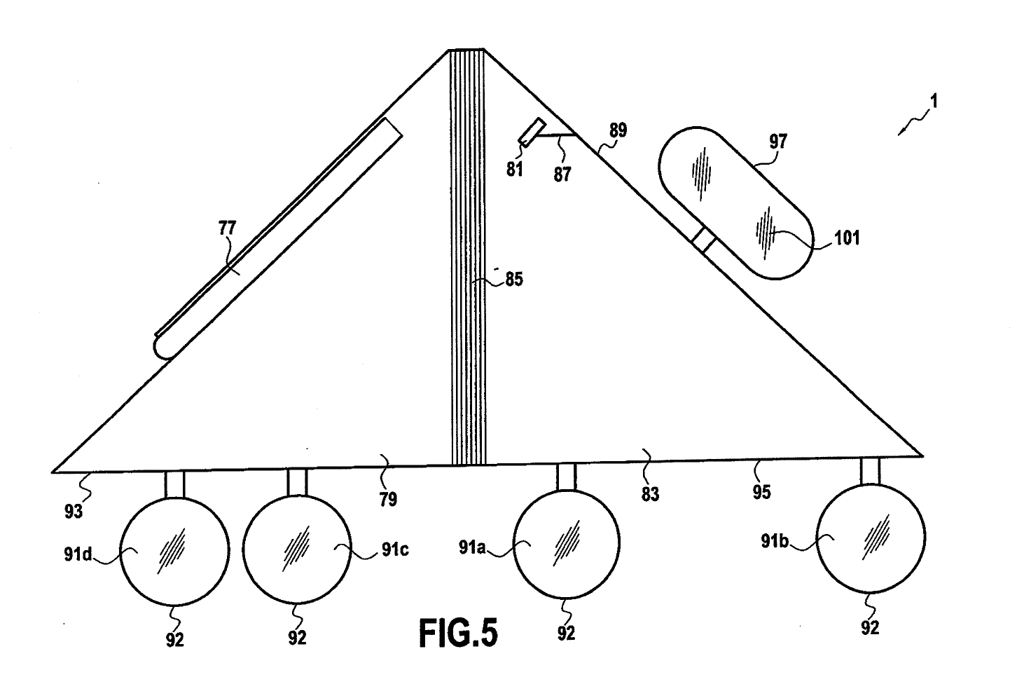

FIG. 5 shows a second variation of embodiment of the binding system, said system being provided in particular with only one tab.

As shown in FIG. 1, the binding system 1 allows the securing of the document 3, particularly an official document such as a contract, a notarial instrument, or even an authentic instrument for which authenticity must be guaranteed. Said document 3 is comprised of at least one page 5 and has a recto side 7 and a verso side 9.

As shown in FIG. 2, the binding system 1 comprises a first strip 11 and a second strip 13. Said strips 11, 13 are connected to each other at a folding zone 15. Said folding zone 15 comprises a width that can be variable, and in particular is a function of the thickness of the document that is to be bound.

The first strip 11 comprises an inner face 17 and an outer face 19. Similarly, the second strip 13 comprises an inner face 21 and an outer face 23. When the two strips 11, 13 are folded at the folding zone 15, they are arranged one above the other, the two inner faces 17, 21 being opposite each other. The two strips 11, 13 are connected to each other at their folding zone 15, for example over the full length of the two adjacent sides 25, 27 of said strips 11, 13, as illustrated in FIG. 2.

As represented in FIG. 1, the first strip 11 comprises at least one tab 29. In a preferred and non-limiting manner, the strip comprises as many tabs as there are perforations in the document. The documents are generally of standard pages provided with two or four perforations. Thus, the binding system 1 preferably comprises two or four tabs arranged on the first strip 11. Shown in FIG. 2 in particular are two tabs 29, 29′ arranged on the first strip 11. Preferably said tabs 29, 29′ are directly cut from the first strip 11. However, a variation of embodiment of the tabs can be considered in which they are sewn on to the inner face 17 of said strip 11.

As shown in FIG. 2, the second strip 13 comprises at least one perforation 31. The number of perforations corresponds in particular to the number of tabs on the first strip 11. Preferably, the second strip 13 thus comprises two or four perforations 31. Represented in FIG. 2 are two perforations 31, 31′, said perforations 31, 31′ being arranged on the second strip 13 so as to correspond to the end 33, 33′ of the tabs 29, 29′, at the place where said tabs 29, 29′ are bent so as to extend perpendicular with respect to the inner face 17, said tabs extending perpendicularly thus being capable of being inserted first into the perforations 34 made in the document 3, then into the perforations 31, 31′ of the second strip 13 when said strips 11 and 13 are folded and arranged opposite each other, as shown in FIG. 3, one of said strips, particularly the first strip 11, being placed on the verso side 9 of the document, and the other, particularly the second strip 13, being placed on the recto side 7 of the document 3. The folding zone is placed according to the thickness of the stacked pages 5 constituting the document 3.

The tabs 29, 29′ are made of a flexible material allowing them first to be bent perpendicular with respect to the inner face of the strip 11, then subsequently to be bent onto the outer face of the second strip as shown in FIG. 1.

As shown in FIG. 1, the inner face 35, 35′ of the tabs 29, 29′ is pressed onto the outer face 23 of the second strip 13. Said inner faces 35, 35′ comprise an adhesive film 37, 37′ that ensures a single attachment of the tab 29, 29′ onto the second strip 13. Said adhesive film thus constitutes irreversible assembly means. The detachment of the tab 29, 29′ results in the detachment of the adhesive film 37, 37′ which then remains integral with the outer face 23 of the second strip 13, as shown in FIG. 3. The detached adhesive film leaves a colored marking on the outer face 23. The detachment of the adhesive film 37, 37′ from the inner face 35, 35′ of the tab 29, 29′ also results in the prevention of the re-adhering of said tab 29, 29′.

As shown in FIG. 2, the adhesive film 37, 37′ comprises a code 39, 39′ that is integrated into the thickness of its material. Said code appears during the marking left by the adhesive film 37, 37′ on the outer face 23 of the strip 13 when the tab 29, 29′ is detached as illustrated in FIG. 3. Said code allows the binding system 1 to be identified, which makes possible the authentication of said system 1, and consequently guarantees that the official document has not been falsified because said binding system is of a single usage only. Said identifying code can be an alphanumeric code such as shown in FIG. 3. However, said identifying code can also be composed of a DNA tracer integrated into the material of the adhesive film, said DNA tracer in particular being decoded when the adhesive film is detached from the tab and remains adhered to the outer face 23 of the strip 13.

As illustrated in FIG. 1, the binding system 1 comprises authentication means such as the bar code 41, said bar code preferably being arranged on one of the outer faces 19, 23 of the strips 11, 13. Said bar code 41 is preferably indelible in order to avoid any risk of falsification thereof.

As represented in FIG. 1, the authentication means comprises at least one hologram 43, which is preferably arranged on the outer face 19, 23 of one of the strips 11, 13. However, said hologram 43 can be placed on the outer face of the folding zone. The purpose of said hologram 43 is also to guarantee the authentication of the binding system 1.

Preferably, the binding system could include one or more of the authentication means cited above, depending on the security level to be defined, according to whether it is a document of lesser importance, for example, or a very significant document. Some of said authentication means, particularly the bar code 41 or the hologram 43, can also have the function of allowing the traceability of the document 3, for example for its filing or computerized referencing.

As represented in FIG. 2, the strips 11, 13 include on their inner face 17, 21 an adhesive film 44, 45 similar to the one on the tabs 29, 29′, so as to allow the adhering of said inner faces 17, 21 to the recto side 7 and verso side 9 of the document 3. Thus, in the event of detachment of the binding system 1 with respect to the recto 7 and verso 9 faces of the document 3, the adhesive film 44, 45 is detached from the inner faces 17, 21, as shown in FIG. 3, and said film 44, 45 then leaves a colored marking, preferably visible to the naked eye, the detachment of the film 44, 45 preventing the re-adhering of the inner faces 17, 21 onto the recto 7 and verso 9 sides of the document.

As shown in FIG. 2, said adhesive film on the inner faces 17, 21 comprises a coding 46 integrated into the material of said film. Said coding 46 appears in particular when the adhesive film 44, 45 is detached from the inner face 17, 21 and remains adhered to the recto side 7 or verso side 9 of the document 3. Said coding in particular makes it possible to identify the document when the binding system 1 has been completely removed. It is thus possible to find the origin of the document, for example when it has been stripped and the criminal, realizing that he cannot use said document, abandons it after having removed the binding system. The identifying code 46 is an alphanumeric type in particular. However, the adhesive film can also include a DNA tracer, accessible in particular when the strips 11, 13 of the binding system 1 are detached from the recto face 7 and verso face 9 of the document 3 and the films 44, 45 remain adhered thereto. Said DNA tracer can constitute the identifying code, or can be provided in addition to the alphanumeric type identifying code, depending on the degree of security to be achieved.

According to a variation of embodiment, the binding system 1 according to the invention can be produced, in all or in part, from a transparent material. Said transparent material can integrate an identifying code 48 (FIG. 1), particularly a color code, said color code preferably being invisible to the naked eye, being read instead by means of a laser for example. Its inclusion in the transparent material makes it inaccessible while remaining readable. Said coding 48 can be provided independent of the other authentication means specified above, or in combination therewith. Moreover, the transparency of the material allows the color code to be read easily when the system 1 is applied to the document 3.

The binding system comprises locking means arranged between the tabs 29, 29′ on the first strip 11 and the perforations 31, 31′ arranged on the second strips 13. The function of said locking means is to prevent the spreading of the two strips 11, 13 folded onto the thickness of the document 3. Indeed, the increase of the spreading can occur during the opening of the document 3 in order to access the intermediate pages 5. This increase can generate stresses on the tabs 29, 29′ that are attached to the outer face 23 of the second strip 13, said stresses possibly able to cause the detachment of the tabs 29, 29′ adhered to said outer face 23, and consequently releasing the adhesive film 37, 37′ adhered to said tabs 29, 29′.

FIGS. 1 to 3 show a first embodiment of these locking means. The tabs 29, 29′ are provided with orifices 47, 47′ and the perforations 31, 31′ are provided with protruding parts 49, 49′ composed in particular by points arranged at the periphery of the perforation 31, 31′ and extending toward the interior thereof. Thus, the protruding part 49, 49′ is capable of being inserted into the orifice 47, 47′ when the tab 29, 29′ is inserted into the perforation 31, 31′ of the second strip 13 and the inner faces 17, 21 are suitably pressed against the recto side 7 and verso side 9 of the document 3. Once the protruding parts 49, 49′ are inserted into the orifices 47, 47′, the tabs 29, 29′ are immobilized with respect to the second strip 13, which avoids exerting stress on said tabs 29, 29′ when they are adhered to the outer face 23.

FIG. 4 represents a second embodiment of these locking means. Thus, the locking means are composed of the shape of the tabs 29, 29′ themselves, which have a non-return system that allows the insertion of the tab 29, 29′ through the perforation 31, 31′, and then prevents the withdrawal of said tab 29, 29′, the non-return system 51, 51′ being locked onto the periphery 53, 53′ of the perforation 31, 31′. The non-return system 51, 51′ presents, for example, the shape of a fir tree composed of a plurality of teeth 55, 55′ having a pitch oriented toward the end 57, 57′ of the tab 29, 29′. Said teeth 55, 55′ in particular are deformable to allow their insertion through the orifice 31, 31′, which has dimensions that are slightly smaller than the end 59, 59′ of said teeth 55, 55′.

As shown in FIGS. 2 and 4, the second strip 13 comprises slits 61, 61′ that are arranged between the periphery 53, 53′ of the perforations 31, 31′ and the longitudinal outer edge 63 of the second strip 13. The deformation of the second strip at said slit 61, 61′ makes it possible to create a passage through said strip 13 to facilitate the insertion of the tab 29, 29′ through the slit 61, 61′, then its positioning through the perforation 31, 31′. Said slit 61, 61′ recloses once the tab 29, 29′ is inserted into the perforation 31, 31′, particularly when any deformation of the second strip 13 at said tab [sic] 61, 61′ ceases.

As shown in FIG. 4, the binding system comprises at least one disc 65, and preferably three discs 65, 67, 69 two of which are arranged at the longitudinal ends of the binding system 1 and the third arranged at the central part of said system 1. As illustrated in FIG. 4, said discs are integral with the strips 11, 13 and extend perpendicular, for example, to the longitudinal folding zone 15 in the same direction as the two strips 11, 13. Said tabs [sic] 65, 67, 69 could possibly be made by cutting them in the strips 11, 13. Said discs 65, 67, 69 are preferably provided with irreversible assembly means 71, 73, 75 such as those provided on the inner face 17, 21 of the strips 11, 13 and on the inner face 35, 35′ of the tabs 29, 29′. Thus, the discs 65, 67, 69 are of single usage and are provided in order to be attached to the recto face or to the verso face of one of the pages 5 of which the document 3 is composed, and preferably the intermediate pages 5, which makes it possible to increase the level of security of the document to be authenticated and to protect, for example, certain pages 5 of the document on which important information is affixed, particularly the signatures. Thus any falsification of the document is prevented. These assembly means 71, 73, 75 on the disc 65, 67, 69 are preferably capable of marking the face of the page 5 on which said disc is attached, in the event it is removed. Similarly, these assembly means prevent the disc from being re-adhered once it is detached from the face on which it was placed.

Furthermore, the central disc 65 is also arranged so as to be glued onto the two tabs 29, 29′ after they have been folded down and attached to the outer face 23 of the second strip 13. Thus, the disc 65 makes it possible to seal both tabs 29, 29′; moreover, preferably the outer face of said disc 65 is capable of receiving the signature of the different parties concerned by the document to be sealed, as well as the date on which the binding system was sealed onto the document.

Depending on the case, said disc 65 is capable of marking the outer face 23 when it is removed from said outer face 23.

According to one embodiment illustrated in FIG. 5, the binding system comprises a single tab 77. Said tab 77 is arranged on a strip 79 and is capable of being inserted through an orifice 81 made in a second strip 83, the two strips 79, 83 being articulated along a folding zone 85 the width of which can possibly be varied according to the thickness of the documents to be sealed. Preferably said second strip 83 is also provided with a slit 87 extending, for example, from one of its edges 89 to the orifice 81. Preferably, the two strips 79, 83 are reduced in length and are limited, for example, to a rectangular or even square shape, or preferably triangular. However, they must be long enough to allow the adhering of the tab 77 onto the outer face of the second strip 83. As illustrated in this FIG. 5, the binding system comprises for example discs 91a, 91b, 91c, 91d such as those described above for the embodiment of FIG. 4. Said discs will preferably be four in number, and placed on the adjacent lateral sides 93, 95 of the strips 79, 83. Said discs 91a, 91b, 91c, 91d are provided with irreversible assembly means 92 such as those described above for the preceding embodiments. Said means allow a single attachment of the disc onto the recto side or verso side of one of the pages of the document to be sealed, said means being capable of marking the recto or verso face of the page to which the disc 91a, 91b, 91c, 91d is sealed in the event said disc is removed. Furthermore, the system also provides an inverted disc 97 to be sealed onto the tab 77 when it is folded down and attached to the furthest side of the second strip 83. Said inverted disc 97 is arranged on the diagonal edge 89 of the second strip 83, and is provided with irreversible assembly means 101, preferably similar to those of the discs 91a, 91b, 91c, 91d; said inverted disc 97 is capable of marking the outer face of the second strip 83 in the event of the removal of said strip.

Said disc 97 is preferably of similar size and shape to the central disc 65 illustrated in FIG. 4, so as to allow the signature of each party concerned by the instrument to be affixed thereto, possibly with the date on which the document was signed.

The binding system according to this embodiment illustrated in FIG. 5 will in particular be sealed in one of the corners of the document, for example the upper left corner, which will facilitate the reading of the document. Depending on the case, it may be necessary to provide an additional perforation in the document that must be positioned more or less precisely, taking into account the dimensions of said security system. However, said system can be laid out on one of the standard perforations of the document.

1. Secured system for binding a document, said document being perforated and having a recto side and a verso side, wherein the system comprises a first strip and a second strip each of which has an inner face and an outer face, and connected to each other by means of a folding zone made between the adjacent longitudinal sides of the two strips, the first strip comprising at least one tab that extends on an inner face of the first strip and arranged so as to be inserted into the perforation of the document, then into a corresponding perforation made in the second strip when the two strips are folded opposite each other on the recto and verso sides of the document, said tab being arranged so as to be folded and attached to the outer face of the second strip in such a way as to maintain the binding system integral with the document, and in that said system comprises at least irreversible assembly means arranged to allow one single attachment of the tab onto the outer face of the second strip.

2. Binding system according to claim 1, comprising means of marking said outer face in the event of removal of the tab.

3. Binding system according to claim 1, comprising authentication means of said binding system integral with the document arranged so as to guarantee the authenticity of said document.

4. Binding system according to claim 1, wherein the irreversible assembly means are composed of an adhesive film arranged on the inner face of the tab to allow the adhering of said inner face onto the outer face of the second strip, said film leaving a colored marking on the outer face and preventing the re-adhering of the tab once detached from the outer face.

5. Binding system according to claim 3, wherein the authentication means comprise at least one identifying code that appears during the marking left by the adhesive film on the outer face of the second strip.

6. Binding system according to either of claim 4, wherein the authentication means comprise a DNA tracer integrated into the adhesive film and released when the tab is detached from the outer face of the second strip.

7. Binding system according to claim 3, wherein the authentication means comprise at least one bar code arranged on one of the outer faces of the two strips.

8. Binding system according to claim 3, wherein the authentication means comprise at least one hologram arranged on one of the outer faces of the two strips.

9. Binding system according to claim 3, wherein the inner faces of the two strips comprise irreversible assembly means arranged to make possible a single attachment of said inner faces on the recto and verso sides of the document.

10. Binding system according to claim 9, wherein the irreversible assembly means on the inner faces are composed of an adhesive film capable of allowing the adhering of said inner faces onto the recto and verso sides of the document, said film leaving a colored marking and preventing the re-adhering of the inner faces once they are detached from the recto and verso sides.

11. Binding system according to claim 10, wherein the authentication means comprise an identifying code that appears during the marking left by the adhesive film on the recto or verso sides.

12. Binding system according to claim 10, wherein the authentication means comprise a DNA tracer integrated into the adhesive films on the inner faces and released when one of the strips is detached from the recto side or the verso side of the document.

13. Binding system according to claim 1, produced at least partially from a transparent material, the authentication means comprising a color code, particularly invisible to the naked eye, integrated into the transparent material.

14. Binding system according to claim 1, comprising locking means arranged between the tab on the first strip and the perforation of the second strip, said locking means being capable of preventing an increase in the space separating the two strips when they are folded onto the thickness of the document being able to generate stresses at the tab attached to the outer face.

15. Binding system according to claim 14, wherein the locking means are comprised of a protruding part arranged at the periphery of the perforation of the second strip and at least one corresponding orifice provided on the tab, said protruding part being capable of being inserted into said orifice when the tab is inserted into the perforation of the second strip and the inner faces of the strips are pressed onto the recto and verso sides of the document.

16. Binding system according to claim 14, wherein the locking means comprise a non-return system arranged on the tab to allow insertion of the tab through the perforation on the second strip, the inserted part of the tab being locked by said perforation so as to prevent release.

17. Binding system according to claim 1, wherein the second strip comprises at least one slit that extends from the perforation to the outer longitudinal edge of said strip, the slit being capable of allowing the passage of the tab in order to facilitate positioning of the tab through said perforation.

18. Binding system according to claim 1, wherein the first strip comprises two or four tabs [sic] cut in said strip, the second strip comprising respectively two or four perforations corresponding to said tabs.

19. Binding system according to claim 1, wherein the document comprises at least two pages and in that the system comprises at least one disc integral with the strips, said disc being provided with irreversible assembly means allowing single attachment to the recto face or verso face of one of the pages of the document, said means being capable of marking said face of the page in the event of removal of the disc.

20. Binding system according to claim 19, wherein the central disc is arranged to seal the two tabs when they are folded down and attached to the outer face of the second strip.

21. Binding system according to claim 1, comprising a single tab arranged on a strip and capable of being sealed onto the outer face of a second strip, said system in particular being designed to be sealed in a corner of the document.

22. Binding system according to claim 21, comprising at least one disc integral with one of the strips, said disc being provided with irreversible assembly means allowing their single attachment to the recto or verso face of one of the pages of the sealed document, said means being capable of marking the face of the page in the event of removal of the disc.

23. Binding system according to claim 21, comprising an inverted disc provided with irreversible assembly means, capable of being sealed on the tab attached to a second strip and capable of marking the outer face of the second strip in the event of removal.
